(19) United States
(12) Patent Application Publication
(10) Pub. No.: US 2015/0006391 A1
(43) Pub. Date: Jan. 1, 2015

(54) Purchase Control Card Image Generation and Transmittal

(71) Applicant: MASTERCARD INTERNATIONAL INCORPORATED, Purchase, NY (US)

(72) Inventor: Domenico Agresta, Dublin (IE)

(21) Appl. No.: 14/313,386

(22) Filed: Jun. 24, 2014

(30) Foreign Application Priority Data
Jun. 26, 2013 (GB) 1311390.7

(51) Int. Cl. G06Q 20/34

(52) U.S. Cl. CPC G06Q 20/351
USPC 705/44; 705/39

(57) ABSTRACT

Some suppliers or merchants require to see an image of a purchase payment card before they will supply their goods or services. In purchase control systems that operate through the generation of VCNs, there is no physical card of which to make an image. Disclosed herein is a method for generating and transmitting a Virtual Card Image associated with a Virtual Card Number (VCN).

### FIELD

The present disclosure relates generally, but not exclusively, to transaction processing systems which allow card issuers to offer their corporate customers a more secure, efficient, and expandable employee payment system through the use of Virtual Card Numbers (VCNs).

### BACKGROUND

In corporate environments where transaction security and the control of corporate spending are both key considerations, VCNs are being used increasingly by organisations as an alternative to providing employees with purchasing cards. Organisations are able to provide their employees with a VCN, attached to which can be key transaction data such as general ledger or cost centre codes. This data can then be passed on to a merchant by the employee in place of payment card details when performing a transaction.

A Virtual Card Number or VCN typically replicates, in plain text format, the details associated with a physical payment card that are required to make a transaction. FIG. 1 illustrates exemplary VCN details. Alongside the card number 101, there are an expiry date 102, a Card Verification Code (CVC) 103, cardholder name and address details 104, a purchase type 105, a transaction amount 106, a transaction type (Single or Multi use) 107, supplier details 108, email instructions 109 and validity period details 110. Further details such as a sort-code number may be provided, or indeed fewer details may be provided.

The VCN details may be sent to a merchant via a secure email, either by the employee or the VCN provider.

VCNs can be limited-use or even single-use, which has significant benefits when it comes to control and security. Should the details of a VCN be misappropriated, the subsequent use of those details is mitigated or even prevented.

Further restrictions can be placed on the use of VCNs. For example, where the VCN details include information relating to a supplier, the VCN may be restricted such that it may only be used with that particular supplier. Restrictions may instead be based on other components of the VCN details or combinations thereof.

In certain circumstances, usually for added security, a merchant may require a purchaser to provide a fax or in-person handoff of a picture displaying the front and back of their payment card. For example, physical copies of cards are often required by car rental companies and hotels or by venues when collecting previously purchased tickets for an event. This functionality is currently not offered by existing VCN-based transaction processing systems because there is no physical card to make a copy of. As a result, organisations where employees often make transactions requiring such a physical copy of the payment card are less likely to implement VCN-based payment systems. Their payment systems would therefore not be as efficient, user-friendly and controllable as would otherwise be the case through the use of VCN-based payment systems.

Accordingly, it is desirable to provide purchasers using VCN transaction processing systems with a means for providing merchants with a card-like representation of the VCN being used to make a transaction.

### SUMMARY

According to a first aspect of the present disclosure, there is provided a method of performing a transaction, said method comprising the steps of: receiving a transaction request at a purchase control server; generating a Virtual Card Number (VCN) at the server; and generating an associated Virtual Card Image at the server.

This method provides a card-like image of a VCN, giving the user the option to provide a suitable alternative to a physical card. As such, existing limitations of current VCN systems are overcome.

The method may further comprise the step of approving the transaction request prior to generating either or both of the VCN and the Virtual Card Image.

The step of receiving a transaction request may include receiving a specified transaction amount.

The VCN may only be used for the specified transaction amount.

The step of approving the transaction request prior to generating either or both of the VCN and the Virtual Card Image may be automatic where the specified transaction amount is below a pre-determined value.

The approval may require a secondary input where the specified transaction amount is above a pre-determined value.

The VCN and associated Virtual Card Image may be a single-use VCN and Virtual Card Image.

The Virtual Card Image may depict front and rear faces of a payment card including the corresponding VCN details.

The method may further comprise the step of transmitting the Virtual Card Image to an electronic device.

The method may further comprise the step of sending a secure email containing the Virtual Card Image to an email address stored on a database accessible by the server.

It may be possible to verify the email address as being that of a user making the transaction request.

The step of receiving a transaction request may include receiving a specified recipient of the transaction, and the email address may be verifiable as being that of the specified recipient.

The Virtual Card Image may comprise an image that cannot be copied or saved.

The Virtual Card Image may comprise an image that can be printed.

The step of generating the Virtual Card Image may comprise retrieving an image from an issuing financial institution with which the VCN is associated, and superimposing VCN details on to that image.

According to a second aspect of the disclosure, there is provided server comprising processing and operating means with executable instructions which on execution cause the server to perform the method as set out in any of the above statements of the disclosure relating to the first aspect of the disclosure.

According to a third aspect of the disclosure, there is provided computer readable medium for a server comprising computer executable instructions which on execution cause the server to perform the method as set out in any of the above statements of the disclosure relating to the first aspect of the disclosure.

### DRAWINGS

Embodiments of the present disclosure will now be described, by way of example only, with reference to the accompanying drawings, in which:

FIG. 1 depicts an exemplary VCN-based transaction request, including VCN details;

FIG. 2 depicts an exemplary operating model of the parties involved in a known VCN-based transaction;

FIG. 3 is a flow diagram of the known processes involved in a VCN-based transaction;

FIG. 4 is a flow diagram of the processes involved in a VCN-based transaction of the present disclosure;

FIG. 5 depicts an exemplary operating model of the parties involved in one embodiment of a VCN-based transaction of the present disclosure;

FIG. 6a depicts the front face of an exemplary Virtual Card Image; and

FIG. 6b depicts an optional rear face of an exemplary Virtual Card Image.

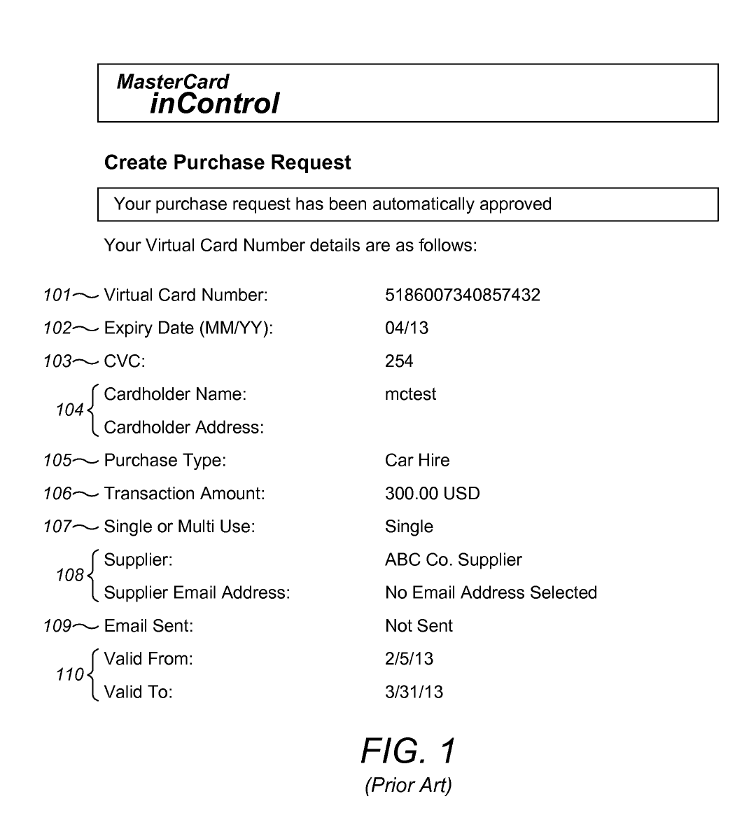

### DETAILED DESCRIPTION

A well-known VCN-based commercial payment system is the MasterCard Purchase Control™ system. This web-based system enables organisations to provide their employees with limited-use VCNs with which transactions can be performed, instead of providing employees with physical purchasing cards. This improves the control, efficiency, compliance and security of transactions.

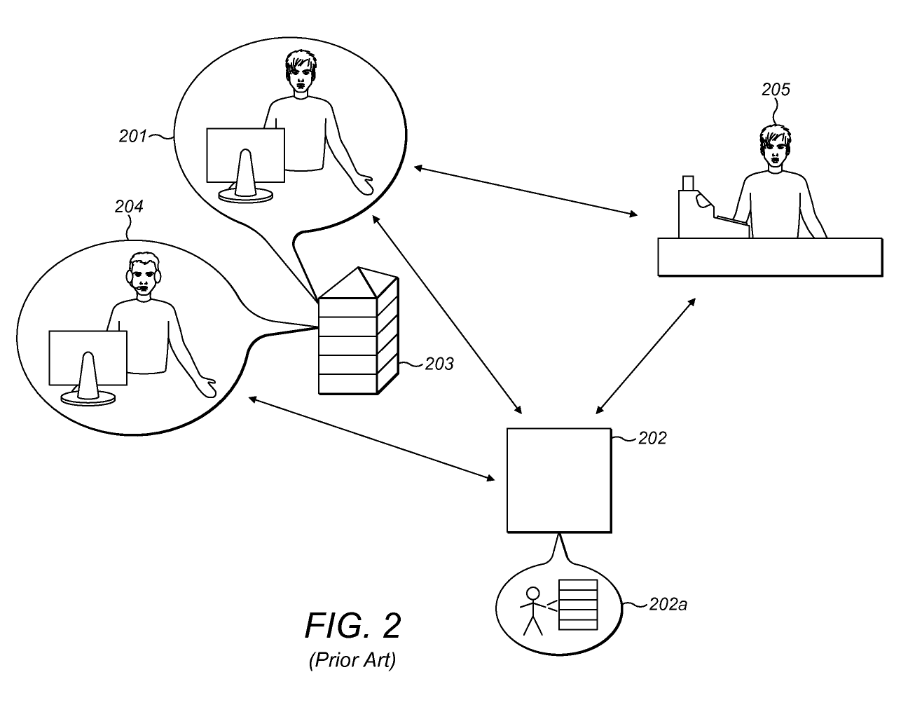

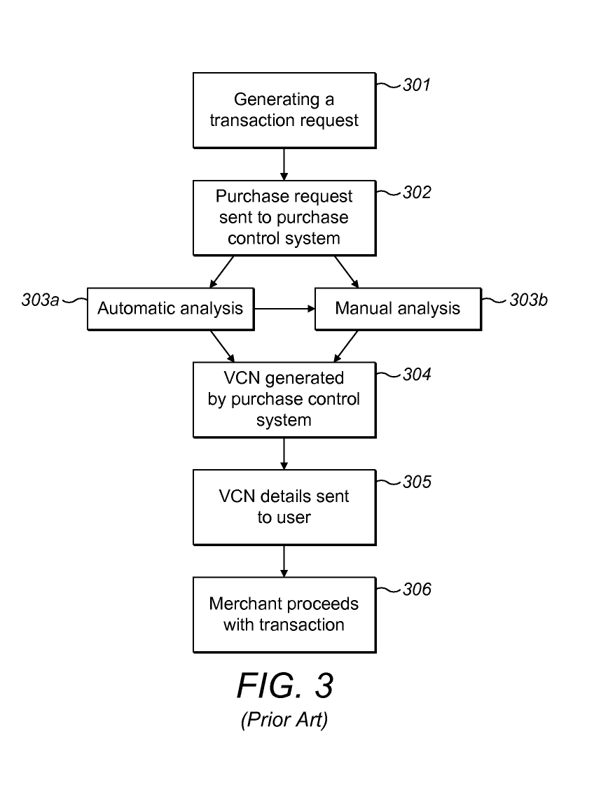

FIGS. 2 and 3 illustrate a successful transaction made using such a VCN-based payment system. The model of FIG. 2 includes a user 201, a purchase control system 202, an organisation 203, an administrator 204 and a merchant 205. The user 201 may, for example, be the employee of the organisation 203 and the administrator 204 may, for example, be employed by the same organisation 203 and may be a financial administrator or a supervisor of the user 201. The purchase control system 202 comprises a platform including at least one server 202a for processing transaction requests and for generating VCNs. The purchase control system 202 may be provided by a third-party, for example, it may be a system such as the MasterCard Purchase Control™ system.

To initiate a transaction, a user 201 generates a new transaction request by selecting appropriate parameters (step 301). These parameters may include but are not limited to details such as the transaction amount, the time and location of the transaction, details of the recipient, etc.

In this instance, this parameter selection step (step 301) comprises filling out a purchase request form which requires the user 201 to select the appropriate parameters. Typically, the user 201 accesses the purchase request form through a website provided by the third-party provider of the purchase control system 202. It will be understood, however, that the parameters may instead be selected or input by any other suitable means, including a hard-copy purchase request form, or other data entry methods.

Once generated, the transaction request is sent to the purchase control system 202 for processing (step 302).

The parameters of the request are then analysed. It may be the case that the parameters are analysed automatically and approval (or rejection) of the transaction request is therefore automatic (step 303a). This automatic analysis comprises comparing the parameters set by the user 201 with pre-defined rules. If the parameters of the transaction request are within the limits of these pre-defined rules, then the request is automatically approved. An exemplary pre-defined rule is that the requested transaction amount must be £3,000 or less. With such a rule, manual analysis by the administrator 204 (step 303b—see below) is only required for higher-value transaction requests. Rules may be created for any parameter or combination of parameters set by the user 201.

The organisation 203 utilising the VCN-based payment system can create unique rules for each employee using the system. For example, the administrator 204 may provide a custom set of rules for each employee. Alternatively, a blanket set of rules for the whole organisation may be created.

Should one or more of the parameters set by the user 201 in a transaction request exceed the limits of the relevant pre-defined rules, the transaction request may either be automatically rejected or the request may be held while the administrator 204 is notified. The administrator 204 can then, as a secondary input, perform a manual analysis of the selected parameters (step 303b) and either reject or approve the transaction request.

Notification may comprise sending an automatically-generated email or SMS to the administrator 204. The notification may comprise details of the transaction request or it may simply notify the administrator 204 that there is a transaction request requiring their attention.

In one embodiment, there are no pre-defined rules and every transaction request is held until the administrator 204 manually analyses and then either rejects or approves the request.

To review and either approve or reject the transaction request, the administrator 204 typically logs on to a website provided by the third-party provider of the purchase control system 202. Where the initial notification of the transaction was sent to the administrator 204 via an email or SMS message, notification of the approval or rejection may be sent via a return email or SMS.

Once a transaction request has been approved, the purchase control system 202 generates a VCN and associated details (step 304). These details may include, for example, account holder name, long number, CVC code, Issuer name, valid from and valid to dates, and expiry date. The generated VCN details are then sent to the user 201, preferably via a secure email to a verifiable email address for that user. The user 201 can then perform a transaction in a conventional manner, supplying the relevant details to the merchant 205 (step 305), as described below.

Alternatively, if the required information is available (for example, having been input at the transaction request step 301), the generated VCN details may be sent directly to the merchant 205 by the purchase control system 202. The merchant may, for example, receive the VCN details via a secure email sent by the purchase control system 202, where the merchant's email details are accessible to the system.

However the merchant 205 receives the VCN details, the merchant 205 can then use the VCN details to proceed with the transaction (step 306) in a conventional manner, seeking authorisation from the financial institution that issued the VCN to charge the purchase to the account associated with the VCN.

The present method relates to a VCN-based purchase control system which enables a user who has successfully submitted a transaction request (and therefore been issued with a VCN) to supply a merchant with a Virtual Card Image along with the VCN details.

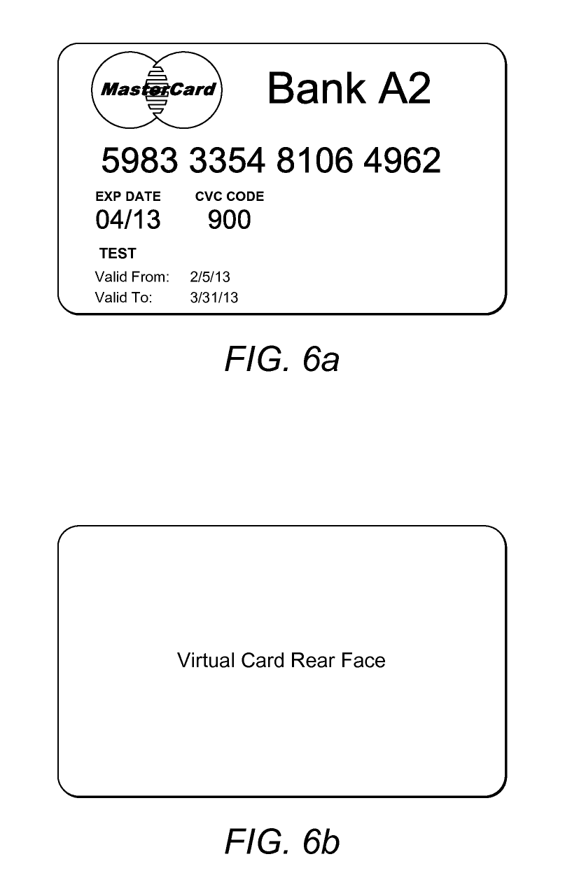

The Virtual Card Image may simulate the front and rear faces of an ordinary physical payment card that includes the corresponding VCN details. FIGS. 6a and 6b respectively depict the front and rear faces of such an exemplary Virtual Card Image. The Virtual Card Image may display some or all of the VCN details including valid to and valid from dates. Alternatively, all of the requisite details may instead be depicted on just a single face of the Virtual Card Image.

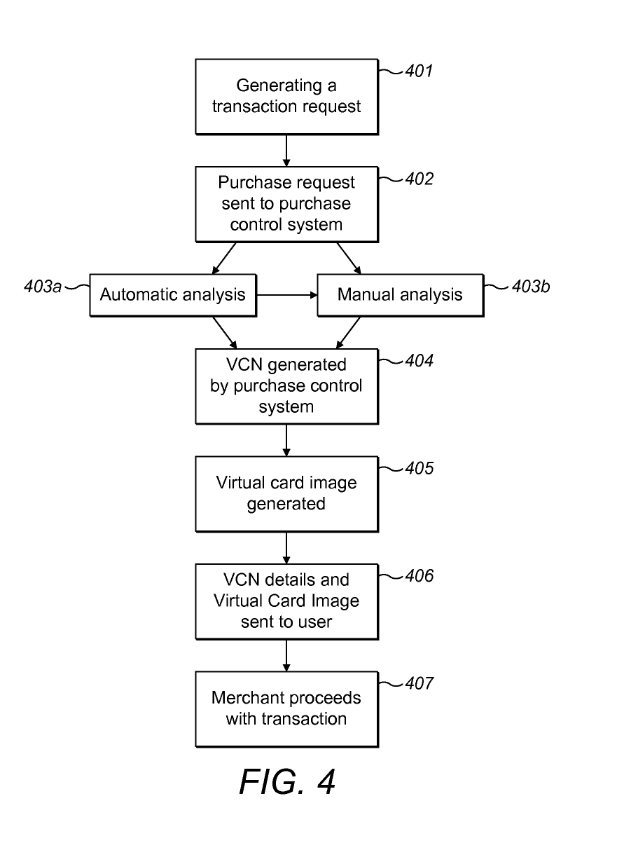

FIG. 4 is a flow diagram of the processes which occur in the present method. Steps 401 to 404 are identical to the corresponding steps 301 to 304 of FIG. 3 and the parties involved are the same as those represented in FIG. 2.

At step 405, a Virtual Card Image is generated using the VCN details generated at step 404, and at step 406 the VCN details and Virtual Card Image are sent to the user 201.

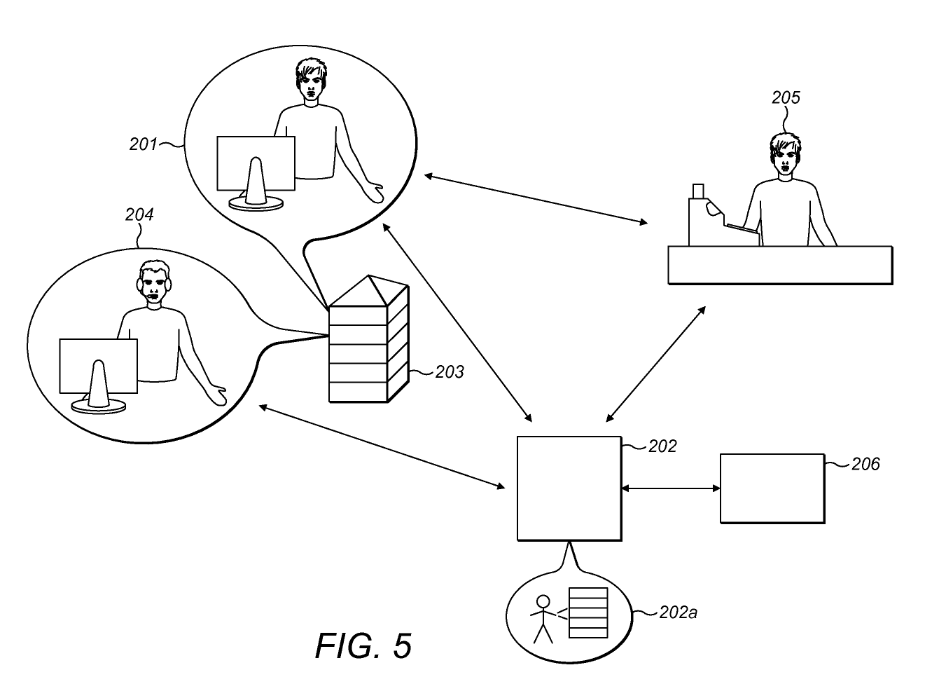

The step 405 of generating the Virtual Card Image may take place at the purchase control system 202. Typically, however, the Virtual Card Image generation step 405 takes place on the client side, for example at a frontend server 206 (shown in FIG. 5) operated by the client, being the financial institution that hosts the account with which the VCN is associated. By generating the Virtual Card Image on the client side, it is not required for the purchase control system 202 to store images for each and every possible financial institution that hosts an account with which a VCN may be associated; rather, each financial institution stores and generates its own image or images.

As an alternative, the step 405 of generating the Virtual Card Image may take place at a terminal belonging to the merchant 205. The entire Virtual Card Image may be generated at the terminal, for example, the terminal may store or have access to a generic template which it can populate with details from the received VCN, advantageously allowing less information to be sent across the network.

The Virtual Card Image may be generated automatically with every approved request. Alternatively, the Virtual Card Image may only be generated when the user 201 has requested that one be generated. Such a request may comprise selecting an appropriate parameter when the transaction request is generated (step 401). For example, the transaction request may comprise a parameter relating to the generation of a Virtual Card Image. In the case of the parameters being input or selected on a form, there could be a simple tick-box to select for a Virtual Card Image to be generated.

As a further alternative, if the user 201 had not previously requested it, upon receiving the VCN, they may be given the option of requesting that a Virtual Card Image be generated. That Virtual Card Image is then generated at the purchase control system 202 or frontend server 206 and sent to the user 201.

The Virtual Card Image may be sent to the user as a PDF, JPEG, TIFF, GIF or png attached to an email. This email may be the secure email containing the VCN details. Alternatively, the Virtual Card Image may be embedded in the body of the email. By being sent to a verifiable email address uniquely associated with the user 201, there is no need for the Virtual Card Image to be password-protected. The Image card may also be printed, either automatically or at the request of the user 201.

The user 201 can then pass the VCN details together with the Virtual Card Image on to the merchant 205 who can then proceed with the transaction (step 407).

The method of the present disclosure enables the user 201 to perform a wider range of transactions using a VCN-based system. Where necessary, the user 201 can now provide a representation of a card corresponding to the VCN details used for a transaction.

The flow charts and descriptions thereof herein should not be understood to prescribe a fixed order of performing the method steps described therein. Rather, the method steps may be performed in any order that is practicable. Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

1. A method of performing a transaction, said method comprising the steps of:
receiving a transaction request at a purchase control server;
generating a Virtual Card Number (VCN) at the purchase control server; and
generating an associated Virtual Card Image.

2. The method of claim 1, further comprising the step of approving the transaction request prior to generating either or both of the VCN and the Virtual Card Image.

3. The method of claim 1, wherein the step of receiving a transaction request includes receiving a specified transaction amount.

4. The method of claim 3, wherein the VCN may be used for the specified transaction amount.

5. The method of claim 2, wherein said approval is automatic when the specified transaction amount is below a pre-determined value.

6. The method of claim 2, wherein said approval requires a secondary input when the specified transaction amount is above a pre-determined value.

7. The method of claim 1, wherein the VCN and associated Virtual Card Image are a single-use VCN and Virtual Card Image.

8. The method of claim 1, wherein the Virtual Card Image depicts front and rear faces of a payment card including the corresponding VCN details.

9. The method of claim 2, further comprising transmitting the Virtual Card Image to an electronic device.

10. The method of claim 1, further comprising sending a secure email containing the Virtual Card Image to an email address stored on a database accessible by the server.

11. The method of claim 10, wherein the email address is verifiable as being that of a user making the transaction request.

12. The method of claim 10, wherein the step of receiving a transaction request includes receiving a specified recipient of the transaction, and wherein the email address is verifiable as being that of the specified recipient.

13. The method of claim 1, wherein the Virtual Card Image comprises an image that cannot be copied or saved.

14. The method of claim 13, wherein the Virtual Card Image comprises an image that can be printed.

15. The method of claim 1, wherein the step of generating the Virtual Card Image comprises retrieving an image from an issuing financial institution with which the VCN is associated, and superimposing VCN details on to that image.

16. A server comprising a processor and a memory having executable instructions that, when executed by the processor, cause the processor to:
generate a Virtual Card Number (VCN) in response to a transaction request; and
generate an associated Virtual Card Image.

17. (canceled)

18. The server of claim 16, wherein the executable instructions, when executed by the processor, cause the processor to generate an approval for the transaction request prior to generating either or both of the VCN and the Virtual Card Image.

19. The server of claim 18, wherein the VCN and associated Virtual Card Image are a single-use VCN and Virtual Card Image.

20. The server of claim 19, wherein said approval is automatic when the specified transaction amount is below a pre-determined value.

21. The server of claim 19, wherein said approval requires a secondary input when the specified transaction amount is above a pre-determined value
